(19) United States
(12) Patent Application Publication
(10) Pub. No.: US 2021/0107209 A1
(43) Pub. Date: Apr. 15, 2021

(54) Articles with Textured Surfaces Having Pseudorandom Protrusions

(71) Applicant: 3M INNOVATIVE PROPERTIES COMPANY, St. Paul, MN (US)

(72) Inventors: Matthew R.C. Atkinson, Grant, MN (US); Jonathan T. Kahl, Woodbury, MN (US); Olester Benson, Jr., Woodbury, MN (US); Lori A. Sjolund, Stillwater, MN (US); Elizabeth D. Cadogan, Vadnais Heights, MN (US); Richard L. Rylander, Stillwater, MN (US)

(21) Appl. No.: 17/046,507

(22) PCT Filed: Apr. 5, 2019
(86) PCT No.: PCT/IB2019/052827

§ 371 Date: Oct. 9, 2020

Related U.S. Application Data
(60) Provisional application No. 62/657,134, filed on Apr. 13, 2018.

(51) Int. Cl. B29C 59/02

(52) U.S. Cl. CPC B29C 59/022; B05D 5/02

(57) ABSTRACT

At least some aspects of the present disclosure direct to an article comprising: a major textured surface having a plurality of ellipsoidal protrusions, wherein the plurality of ellipsoidal protrusions is disposed in repeated units, and wherein each of the repeated units has a pseudorandom pattern, such that is a degree of short range regularity of the pseudorandom pattern is greater than 0.5 and a degree of long range regularity of the pseudorandom pattern is less than 0.5.

### TECHNICAL FIELD

This disclosure relates to articles having a textured surface.

### BACKGROUND

Consumer products often require a surface with haptic perception (i.e., haptically interactable). Touch perception plays an integral role in the user experience. Human touch perception is one of the most complex perceptual systems of the human nervous system. Multiple sensory receptors located in the skin combine to provide information about one's haptic (i.e., “touch”) experience. Each receptor is specialized to transduce specific information about the environment into a meaningful electrical signal for the central nervous system to further process. The perception of texture, compressibility, stickiness, and temperature all occur through complex firing patterns that are provided by various haptic sensory receptors found at or near the skin. Certain firing patterns of haptic sensory receptors can provide information about the material properties that the body is in contact which that are preferred or aversive. The relationship between skin and these material properties create complex mappings to preference that are also extremely specific to a particular purpose or application.

### SUMMARY

There is a need for articles having specific surface textures, and methods of making such textures, that provide surfaces of the articles with a preferred haptic experience. These article surface textures have geometric features and surface roughness parameters that are distinctly different from surfaces found on conventional articles.

At least some aspects of the present disclosure direct to an article comprising: a major textured surface having a plurality of ellipsoidal protrusions, wherein the plurality of ellipsoidal protrusions is disposed in repeated units, and wherein each of the repeated units has a pseudorandom pattern, such that a spatial FFT spectrum of the pseudorandom pattern has one or more rings and has a relatively high spectral energy proximate to the rings and relatively low spectral energy away from the rings.

At least some aspects of the present disclosure direct to an article comprising: a major textured surface having a plurality of ellipsoidal protrusions, wherein the plurality of ellipsoidal protrusions is disposed in repeated units, and wherein each of the repeated units has a pseudorandom pattern, such that a degree of short range regularity of the pseudorandom pattern is greater than 0.7 and a degree of long range regularity of the pseudorandom pattern is less than 0.5.

### BRIEF DESCRIPTION OF DRAWINGS

FIG. 1A is a topographic map of one example of a textured surface (2×2 square millimeter field of view).

FIG. 1B is a unit of the repeated patterns of the textured surface illustrated in FIG. 1A.

FIG. 2A is a spatial FFT of the textured surface illustrated in FIG. 1B.

FIG. 2B is a graph showing the differences between the degrees of short range regularity and long range regularity, for pseudorandom, regular and random patterns.

FIG. 3 is a representative line profile across a protrusion of one example of a textured surface.

FIG. 4 is a map of x-curvature of one example of the presently disclosed textured surface.

FIG. 5 is a map of y-curvature of one example of the presently disclosed textured surface.

FIG. 6 is a combined map of the two curvature maps in x- and y-directions as shown in FIGS. 4 and 5.

FIG. 7 is a representative topographical map of one example of the presently disclosed textured surface, oblique view, map area=2.0×2.0 millimeter.

FIG. 8 is an envelope of the top surface defined by the tops of the protrusions of one example of the presently disclosed textured surface.

FIG. 9 is an image of a portion of an example tool showing the semi-random spacing of the cavities.

FIG. 10 is an image showing a portion of the article produced using the tool illustrated in FIG. 9.

FIG. 11 is a schematic representation of an example process for making an article with a textured surface.

### DETAILED DESCRIPTION

Before any embodiments of the present disclosure are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated. These are only examples of what is specifically intended, and all possible combinations of numerical values between and including the lowest value and the highest value enumerated are to be considered to be expressly stated in this application.

The term “textured surface” as used herein means that a major surface of the article has protrusions, such as ellipsoidal protrusions, that are 10 to 75 micrometers wide, where centers of these protrusions are a distance of 25 to 100 micrometers from each other, and where the major surface the article has between 200 to 1000 protrusions per square millimeter.

The term “ellipsoidal protrusions” as used herein means protrusions having an aspect ratio of between 1 and 1.49.

The term “aspect ratio” as used herein means the ratio of an end to end length of the ellipsoidal protrusion to a side to side width of the ellipsoidal protrusion taken from at least 5 microns below the top surface of the ellipsoidal protrusion when looking at the ellipsoidal protrusion from a top plan perspective view of the major textured surface.

The term “plurality” as used herein means at least more than two protrusions. In some embodiments the term “plurality” may mean between 200 and 1000 ellipsoidal protrusions per square millimeter.

The term “irregular” as used herein means protrusions or particles that are not ellipsoidal or hemispherical. Irregular protrusions are typically identified using surface profilometry with settings familiar to those skilled in the art. First, an image feature is defined as the portion of a protrusion with height within 5 micrometers of the peak of the protrusion and its area is measured. Next, the perimeter of the image feature is measured. The metric of regularity is defined as the ratio of the image feature area to the area calculated for an ellipsoid of the same perimeter. A metric below 0.85 or above 1.15 indicates an irregular feature.

It some cases, a highly periodic micro pattern would be perceived by the end user unfavorably. Specifically, the sound produced while running one's finger on such samples was perceived unfavorably by participants (it sounded scratchy and sharp-like running finger nail on a vinyl record). In some cases, a structure having completely random protrusions could introduce too much variance that could be haptically perceived by the user across regions of the material samples. At least some embodiments of the present disclosure direct to textured surfaces having consistently inconsistent protruded features and methods of making those. At least some embodiments of the present disclosure direct to textured surfaces having pseudorandom spaced protrusions.

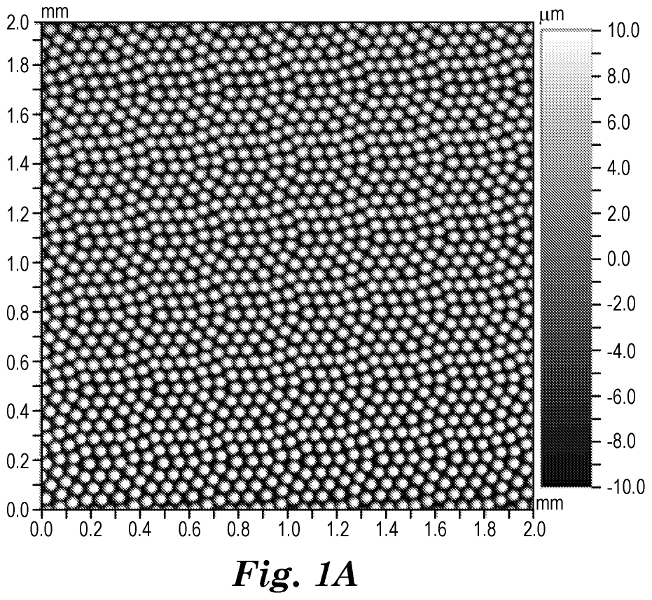

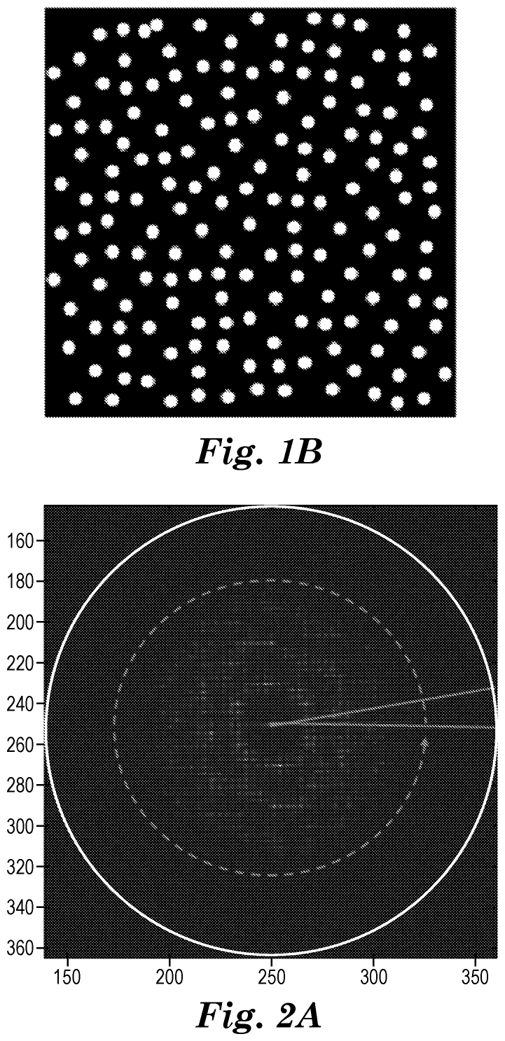

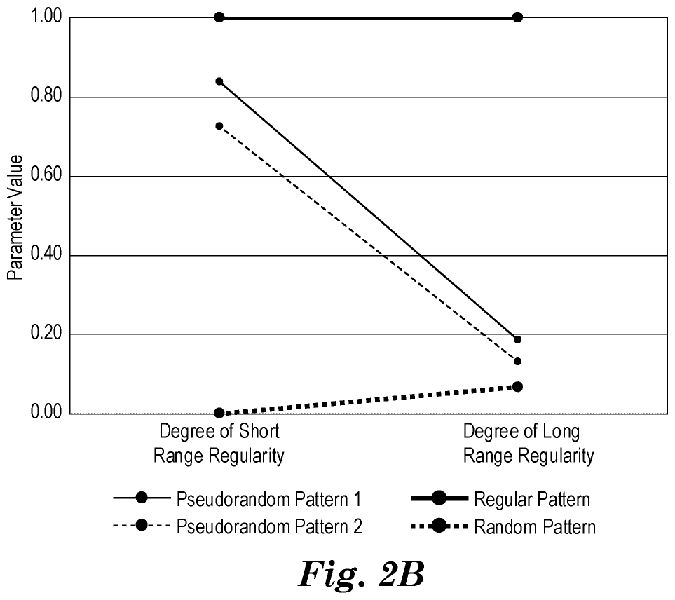

In some embodiments, a major textured surface has a plurality of protrusions, where the plurality of protrusions is disposed in a repeated unit pattern and each unit has pseudorandom spaced protrusions, as illustrated in FIGS. 1A and 1B. The pseudorandom pattern has a spatial FFT spectrum, as illustrated in FIG. 2A, has one or more rings, where the spatial FFT spectrum has a relatively high spectral energy proximate to the rings and relatively low spectral energy away from the rings.

The term “a degree of short range regularity” refers to the normalized nearest neighbor distance coefficient of variation minus by one, where the normalization is performed using the nearest neighbor distance coefficient of variation for a random map with the same protrusion density. The random map or pattern refers to a pattern where the density of protrusions is the same as the sample in question, for example 300 features per mm², where the locations of the protrusions are randomly distributed on the map in both lateral directions, with a uniform random distribution for position, as opposed for example to Gaussian or Normal distributions. The equation to calculate degree of short range regularity is:

$$Degree of short range regularity = 1 - \frac{CoV of nearest neighbor distance}{CoV of nearest neighbor distance for random map}$$

The term “a degree of long range regularity” refers to the normalized azimuth angle coefficient of variation, where the normalization is performed using the azimuth angle coefficient of variation for a regular map with the same protrusion density. The regular map or pattern refers to a map where the density of protrusions is the same as the sample in question, for example 300 features per mm², where the protrusions are distributed on a perfectly repeating grid, for example, disposed in rectangular or hexagonal pattern. In a perfectly repeating map, the nearest neighbors around each protrusion have consistent spacings and relative positions, so that the local region around every protrusion would look the same, regardless of its location on the map. The equation to calculate a degree of long range regularity is:

$$Degree of long range regularity = \frac{CoV of Azimuth intensity plot}{CoV of Azimuth intensity plot for a regular map}$$

The azimuth intensity plot is obtained from the magnitude of the 2D spatial FFT calculated from the positions of the tops of the protrusions in the following manner. The magnitude of the 2D FFT is integrated in a wedge subtending 5 degrees, as indicated by the solid radial lines in FIG. 2A, for azimuthal positions around the center of the 2D spatial FFT as indicated by the dashed circular arrow. The integration is from the center of the plot to a frequency distance equal to the maximum frequency position along either the horizontal or vertial axes, which is indicated by the large circle indicated by a solid line in FIG. 2A. Performing this integration results in a plot of integrated FFT magnitude as a function of azimuth position, which is called the azimuth intensity plot; from this plot the average value and standard deviation are calculated, and the coefficient of variation (CoV) is calculated.

In some embodiments, a pseudorandom pattern has a degree of short range regularity of the pattern greater than 0.5 and a degree of long range regularity of the pattern less than 0.5. In some embodiments, a pseudorandom pattern has a degree of short range regularity of the pattern greater than 0.7 and a degree of long range regularity of the pattern less than 0.5. In some embodiments, a pseudorandom pattern has a degree of short range regularity of the pattern greater than 0.7 and a degree of long range regularity of the pattern less than 0.4. In some embodiments, a pseudorandom pattern has a degree of short range regularity of the pattern greater than 0.8 and a degree of long range regularity of the pattern less than 0.4. As illustrated in FIG. 2B, different surface patterns have different regularity parameters, where a pseudorandom pattern is different from a random pattern or a regular pattern.

When determining the surface characteristics of the presently disclosed major textured surface, it is useful to define top surface envelope. The top surface envelope describes the part of the major textured surface that a user's finger would contact. Envelope Rq represents the root mean squared (RMS) roughness, or the standard deviation of the height values of the surface envelope defined by the tops of the protrusions. The following formula can be used to calculate Rq:

$$Rq = \sqrt{\frac{{\sum }_{i = 1}^{n} {( {Z}_{i} - \overline{Z} )}^{2}}{n}}$$

where Zi is the height of the top of the ith protrusion, Z̅ is the mean height of the tops of all the protrusions and n is the total number of protrusions analyzed.

Envelope Rp is the maximum peak height or the height difference between the mean of the surface defined by the tops of all the protrusions, Z̅, and the top of the highest protrusion in the chosen evaluation region (e.g., 1×1 square millimeter region) max(Z). The following formula can be used to calculate Rp:

Rp=max(Z)−Z̅

Rt is the peak to valley height difference calculated over an evaluation length (e.g., 1 millimeter), and is an indicator of the average height of the surface protrusions.

At least some embodiments of the present disclosure provide an article having a major textured surface that has an envelope Rq of less than 2.25 micrometers, preferably an envelope Rq of less than 2.20 micrometers, and more preferably an envelope Rq of less than 2.00 micrometers. The present disclosure provides an article having a major textured surface that has an envelope Rp of less than 5.5 micrometers, preferably an envelope Rp of less than 5.25 micrometers, and most preferably an envelope Rp of less than 5.00 micrometers.

Some embodiments of the present disclosure have an Rt of greater than 10 micrometers, preferably an Rt greater than 13.5 micrometers, where the textured surface has a plurality of ellipsoidal protrusions.

In some embodiments, a plurality of the protrusions on the major textured surface are ellipsoidal protrusions. In some embodiments, the ellipsoidal protrusions are about 10 to 75 micrometers wide. In some embodiments, the ellipsoidal protrusions have an aspect ratio of between 1 and 1.49. In some embodiments, the ellipsoidal protrusions are hemispherical in shape. In some embodiments, the centers of the ellipsoidal protrusions are a distance of about 25 to 100 micrometers from each other. In some embodiments, the major textured surface comprises between about 200 and 1000 ellipsoidal protrusions per square millimeter.

In some embodiments, the ellipsoidal protrusions are microspheres. In some embodiments, the microspheres are about 10 to 75 micrometers wide. In some embodiments, the centers of the microspheres are a distance of about 25 to 100 micrometers from each other. In some embodiments, the major textured surface comprises between about 200 and 1000 microspheres per square millimeter.

In some embodiments, the ellipsoidal protrusions are a mixture including at least one of the following hemispherical shaped protrusions, ellipsoidal protrusions having an aspect ratio of between 1 and 1.49, microspheres, and combinations thereof. In some embodiments, the ellipsoidal protrusions comprise less than 5 wt % of irregular shaped particles, preferably less than 3 wt % irregular shaped particles, most preferably the microspheres comprise less than 1 wt % of irregular shaped particles. In some embodiments, the microspheres comprise less than 5 wt % of irregular shaped particles, preferably less than 3 wt % irregular shaped particles, most preferably the microspheres comprise less than 1 wt % of irregular shaped particles.

In some embodiments, the textured surface has a preference rating of at least 6.40 according to the Haptic (Touch) Perception test method described hereinafter (the “Haptic (Touch) Perception test”), in which stickiness and roughness of the textured surface are correlated to a user preference rating. In some embodiment, the textured surface has a preference rating of between 6.40 and 10.00 according to the Haptic (Touch) Perception test. In some embodiments, the textured surface has a preference rating of at least 7.00 according to the Haptic (Touch) Perception test. In some embodiment, the textured surface has a preference rating of between 7.00 and 10.00 according to the Haptic (Touch) Perception test. In some embodiments, the textured surface has a preference rating of at least 7.25 according to the Haptic (Touch) Perception test. In some embodiment, the textured surface has a preference rating of between 7.25 and 10.00 according to the Haptic (Touch) Perception test.

In some embodiments, the presently disclosed major textured surface has a RoC, mean sharp greater than or equal to 3.2 micrometers, preferably greater than 5.0 micrometers. RoC, mean sharp is a representation of the radius of curvature of the sharpest feature on the major textured surface in the chosen evaluation region (e.g., 1×1 square millimeter region). The smaller the radius of curvature, the sharper the feature.

In some embodiments, the presently disclosed major textured surface also includes some smooth surface domains. These smooth surface domains can be bounded by textured domains within the major textured surface. Alternately, these smooth surface domains can be positioned along the perimeter or edges of the article. In some embodiments, the presently disclosed textured surface can include both options of smooth surface domains bounded by textured domains within the major textured surface and smooth surface domains placed along the edges or perimeters of the article.

In some embodiments, the ellipsoidal protrusions are disposed on a first major surface of a binder resin layer. In some embodiments, the plurality of ellipsoidal protrusions is a plurality of microspheres partially embedded and adhered to the first major surface of the binder resin layer. In some embodiments, the textured surface has an area percent of less than 7.5% of irregular shaped protrusions, preferably less than 5.6% of irregular shaped protrusions, and more preferably less than 2.7% of irregular shaped protrusions, based on the area of all protrusions. In some embodiments, the feature density of the ellipsoidal protrusions is in a range of 200 to 1000 per square millimeter.

In some embodiments, the ellipsoidal protrusions are composed of the same material as the binder resin layer, and made, for example, by casting and curing a film of the binder resin layer over a textured surface such that the texture transfers to the surface of the binder resin layer. In some embodiments, the textured surface can comprise ellipsoidal sockets, or voids.

In some embodiments, the protrusions are composed of a material different from the binder resin layer material, where the different material can be mixed into the binder resin layer material.

In some embodiments, the present disclosed articles are thermoformable articles having at least a first surface that includes a binder resin layer having a fluorine-containing polymer where the binder resin layer has a first major surface opposite a second major surface; and a plurality of microspheres partially embedded in the first major surface of the binder resin layer and adhered thereto, where the fluorine-containing polymer is a partially fluorinated polymer derived from two or more non-fluorinated monomers having at least one functional group. The present disclosure also provides thermoset articles made using these thermoformable articles.

The fluorine-containing polymers useful in the present disclosure include those that include “dual cure chemistry”. The term “dual cure chemistry” as used herein refers condensation and free radical mechanisms as dual curing mechanisms. For example, formulations that first cure through a first condensation cure mechanism, such as two part urethane chemistry, are useful for making a binder resin layer according to the present disclosure. Thermoformable articles made using these binder resin layers are lightly crosslinked and may be thermoformed and then subsequently cured via a free radical or acid catalyzed cure mechanism to cure latent functionalities, such as for example (meth)acrylates, (meth)acrylamides, epoxides, and the like to further crosslink the binder resin layer into a thermoset. Thermoforming thermosets is very difficult as the crosslinks prevent appreciable elongation, which is required in thermoforming complex shapes. The increase in crosslink density results in higher film hardness and stain resistance, both desirable features for the presently disclosed thermoformable articles.

In some embodiments, it is preferred that the presently disclosed articles are stain resistant. In some embodiments, it is preferred that the article is resistant to organic solvents. In order for the article to be stain resistant and/or resistant to organic solvents, the materials in the article, such as the binder resin layer, must have certain properties.

First, when the article is exposed to highly staining agents, such as yellow mustard, blood, wine, etc. it must be resistant to the staining agent. If the article is not stain resistant then the decorative products to which it is applied may lose their aesthetic appeal even while retaining their functionality. However, stain resistance under ambient conditions (e.g., 23° C. (73° F.) and 50% relative humidity) is insufficient. The decorative products to which the articles of the disclosure may be applied may be exposed to elevated temperatures and humidity. While many materials may provide adequate stain resistance at ambient conditions they often fail to provide sufficient stain resistance when exposed to more demanding environments for prolonged times, such as at 66° C. (150° F.) and 85% relative humidity for 72 hours.

When the article is exposed to highly staining agents it is necessary for the outer surface to be both resistant to discoloration at the surface as well as impervious to penetration into the subsurface by the staining agent.

While not wishing to be bound by theory, it is believed that any, or all, of surface energy, crystallinity, solubility parameters, crosslink density, and film surface continuity characteristics play a role in providing resistance to surface discoloration and/or subsurface penetration. While fluoropolymers are generally known to possess desirable properties that may improve stain resistance they are difficult to process and adhere to. It has been found that certain fluorine-containing polymers may be suitably processed, and adhered to, to provide articles having a high degree of stain resistance. It was also found that the selection of particular amounts and locations of the fluorine atoms in the fluorine-containing polymer of the binder resin when combined with the presently disclosed curing agent provide sufficient stain resistance with decorative film manufacture and use.

The number and placement of functional groups in the non-fluorinated monomers used in the presently disclosed fluorine-containing polymers reduced staining and degradation by solvents in the resulting thermoformed articles after curing. These benefits were recognized while maintaining the ability to thermoform the materials, including satisfactory surface characteristics related to uniformity in surface texture of the resulting thermoformed articles.

A coefficient of friction value of less than or equal to 0.3 is desirable for some embodiments of the present disclosure. Abrasion resistance, as measured by a rotary Taber abraser and measuring the change in % haze, is desirably 10 or less, or 5 or less, or even 3.5 or less for some embodiments of the present disclosure. Pencil hardness values of, for example, of 3H at a force of 5 Newtons, or 1H at a force of 7.5 Newtons, or harder, are desirable for some embodiments of the present disclosure. In some embodiments, the pencil hardness is greater than or equal to 9H at a force of 7.5 Newtons.

Textured articles made according to the present disclosure are preferably thermoformable articles. In some embodiments, these articles are thermoset articles. The present disclosure contemplates thermoformable and/or thermoset articles useful across a range of shapes, sizes, and configurations. In some embodiments, the thermoformable and/or thermoset articles are substantially flat. In the course of thermoforming, some articles may be deformed and permanently strained or stretched. In some embodiments, the thermoformable and/or thermoset articles are 3 dimensional, such as, for example, a five sided box. In some embodiments, the corners or edges can have sharp angles, such as 90 degree angles or higher. Without wishing to be bound by theory, it is believed that the strain on the materials used to make these types of 3 dimensional articles can range from 40 to 50% strain. In some embodiments useful in the present disclosure, the thermoformable and/or thermoset articles have more gradual contours, such as, for example, sloped or curved edges. Without wishing to be bound by theory, it is believed that the strain on these more gradual contoured 3 dimensional articles is lower than the aforementioned 3 dimensional articles. For example, strains in the range of 10 to 20% strain may be observed in articles having more gradual contours. Additionally strains less than 10% are sometimes observed.

In some embodiments, the presently disclosed articles exhibits a stain resistance to yellow mustard at elevated temperature and humidity as measured by the change in b* (of the CIE L*a*b* color space) of less than 50, preferably less than 30, and more preferably 20. In some embodiments, the cured thermoset article is resistant to organic solvents, such as for example methyl ethyl ketone, as well as ethyl acetate.

The transfer coating method of the present disclosure can be used to form the presently disclosed textured film transfer article from which, in some embodiments, can be formed the presently disclosed article. The presently disclosed transfer carrier includes a support layer and a thermoplastic release layer bonded thereto. In some embodiments, the thermoplastic release layer of the transfer carrier temporarily partially embeds a plurality of microspheres. The transfer carrier has low adhesion to the plurality of microspheres and to the binder resin layer in which the opposite sides of the plurality of microspheres are partially embedded, so that the transfer carrier can be removed to expose the surface of the major textured surface.

The support layer should be “dimensionally stable”. In other words, it should not shrink, expand, phase change, etc. during the preparation of the transfer article. Useful support layers may be thermoplastic, non-thermoplastic or thermosetting, for example. One skilled in the art would be able to select a useful support layer for the presently disclosed transfer article. If the support layer is a thermoplastic layer it should preferably have a melting point above that of the thermoplastic release layer of the transfer carrier. Useful support layers for forming the transfer carrier include but are not limited to those selected from at least one of paper and polymeric films such as biaxially oriented polyethylene terephthalate (PET), polypropylene, polymethylpentene and the like which exhibit good temperature stability and tensile so they can undergo processing operations such as bead coating, adhesive coating, drying, printing, and the like.

Useful thermoplastic release layers for forming the transfer carrier include but are not limited to those selected from at least one of polyolefins such as polyethylene, polypropylene, organic waxes, blends thereof, and the like. Low to medium density (about 0.910 to 0.940 g/cc density) polyethylene is preferred because it has a melting point high enough to accommodate subsequent coating and drying operations which may be involved in preparing the transfer article, and also because it releases from a range of adhesive materials which may be used as the binder resin layer.

In some embodiments, thickness of the thermoplastic release layer is chosen according to the microsphere diameter distribution to be coated. The binder resin layer embedment becomes approximately the complement image of the transfer carrier embedment. For example, a transparent microsphere which is embedded to about 30% of its diameter in the release layer of the transfer carrier is typically embedded to about 70% of its diameter in the binder resin layer. To maximize slipperiness and packing density of the plurality of microspheres, it is desirable to control the embedment process so that the upper surface of smaller microspheres and larger microspheres in a given population end up at about the same level after the transfer carrier is removed.

For these embodiments, in order to partially embed the plurality of microspheres in the release layer, the release layer should preferably be in a tacky state (either inherently tacky and/or by heating). The plurality of microspheres may be partially embedded, for example, by coating a plurality of microspheres on the thermoplastic release layer of the transfer carrier followed by one of (1)-(3):(1) heating the microsphere coated transfer carrier, (2) applying pressure to the microsphere coated transfer carrier (with, for example, a roller) or (3) heating and applying pressure to the microsphere coated transfer carrier.

For a given thermoplastic release layer, the microsphere embedment process is controlled primarily by temperature, time of heating and thickness of the thermoplastic release layer. As the thermoplastic release layer is melted, the smaller microspheres in any given population will embed at a faster rate and to a greater extent than the larger microspheres because of surface wetting forces. The interface of the thermoplastic release layer with the support layer becomes an embedment bounding surface since the microspheres will sink until they are stopped by the dimensionally stable support layer. For this reason, it is preferable that this interface be relatively flat.

The thickness of the thermoplastic release layer should be chosen to prevent encapsulation of most of the smaller diameter microspheres so that they will not be pulled away from the binder resin layer when the transfer carrier is removed. On the other hand, the thermoplastic release layer must be thick enough so that the larger microspheres in the plurality of transparent microspheres are sufficiently embedded to prevent their loss during subsequent processing operations (such as coating with the binder resin layer, for example).

Microspheres are useful as protrusions on the presently disclosed major textured surface. Microspheres useful in the present disclosure can be made from a variety of materials, such as glass, polymers, glass ceramics, ceramics, metals and combinations thereof. In some embodiments, the microspheres are glass beads. The glass beads are largely spherically shaped. In some embodiments, the microspheres can have an aspect ratio of between 1 and 1.49. The glass beads are typically made by grinding ordinary soda-lime glass or borosilicate glass, typically from recycled sources such as from glazing and/or glassware. Common industrial glasses could be of varying refractive indices depending on their composition. Soda lime silicates and borosilicates are some of the common types of glasses. Borosilicate glasses typically contain boria and silica along with other elemental oxides such as alkali metal oxides, alumina etc. Some glasses used in the industry that contain boria and silica among other oxides include E glass, and glass available under the trade designation “NEXTERION GLASS D” from Schott Industries, Kansas City, Mo., and glass available under the trade designation “PYREX” from Corning Incorporated, New York, N.Y.

In some embodiments, microspheres useful in the present disclosure are transparent and have a refractive index of less than about 1.60. In some embodiments, the microspheres are transparent and have a refractive index of less than about 1.55. In some embodiments, the microspheres are transparent and have a refractive index of less than about 1.50. In some embodiments, the microspheres are transparent and have a refractive index of less than about 1.48. In some embodiments, the microspheres are transparent and have a refractive index of less than about 1.46. In some embodiments, the microspheres are transparent and have a refractive index of less than about 1.43. In some embodiments, the plurality of microspheres are transparent microspheres having refractive indices that are less than a refractive index of the binder resin layer.

The grinding process yields a wide distribution of glass particle sizes. The glass particles are spherodized by treating in a heated column to melt the glass into spherical droplets, which are subsequently cooled. Not all microspheres are perfect spheres. Some are oblate, some are melted together and some contain small bubbles.

Microspheres are preferably free of defects. As used herein, the phrase “free of defects” means that the microspheres have low amounts of bubbles, low amounts of irregular shaped particles, low surface roughness, low amount of inhomogeneities, low amounts undesirable color or tint, or low amounts of other scattering centers.

The microspheres are typically sized via screen sieves to provide a useful distribution of particle sizes. Sieving is also used to characterize the size of the microspheres. With sieving, a series of screens with controlled sized openings is used and the microspheres passing through the openings are assumed to be equal to or smaller than that opening size. For microspheres, this is true because the cross-sectional diameter of the microsphere is almost always the same no matter how it is oriented to a screen opening. In some embodiments, a useful range of average microsphere diameters is about 5 micrometer to about 200 micrometer (typically about 35 to about 140 micrometer, preferably about 35 to 90 micrometer, and most preferably about 38 to about 75 micrometer). A small number (0 to 5% by weight based on the total number of microspheres) of smaller and larger microspheres falling outside the 20 to 180 micrometer range can be tolerated. In some embodiments, a multi-modal size distribution of microspheres is useful.

In some embodiments, to calculate the “average diameter” of a mixture of microspheres one would sieve a given weight of particles such as, for example, a 100 gram sample through a stack of standard sieves. The uppermost sieve would have the largest rated opening and the lowest sieve would have the smallest rated opening. For our purposes the average cross-sectional diameter can be effectively measured by using the following stack of sieves.

TABLE 1

| U.S. | |
|---|---|
| Sieve | Nominal |
| Designation | Opening |
| No. | (micrometers) |
| 80 | 180 |
| 100 | 150 |
| 120 | 125 |
| 140 | 106 |
| 170 | 90 |
| 200 | 75 |
| 230 | 63 |
| 270 | 53 |
| 325 | 45 |
| 400 | 38 |

Alternately, average diameter can be determined using any commonly known microscopic methods for sizing particles. For example, optical microscopy or scanning electron microscropy, and the like, can be used in combination with any image analysis software. For example, software commercially available as free ware under the trade designation “IMAGE J” from NIH, Bethesda, Md.

In some embodiments, the microspheres are treated with an adhesion promoter such as those selected from at least one of silane coupling agents, titanates, organo-chromium complexes, and the like, to maximize their adhesion to the binder resin layer, especially with regard to moisture resistance.

The treatment level for such adhesion promoters is on the order of 50 to 1200 parts by weight adhesion promoter per million parts by weight microspheres. Microspheres having smaller diameters would typically be treated at higher levels because of their higher surface area. Treatment is typically accomplished by spray drying or wet mixing a dilute solution such as an alcohol solution (such as ethyl or isopropyl alcohol, for example) of the adhesion promoter with the microspheres, followed by drying in a tumbler or auger-fed dryer to prevent the microspheres from sticking together. One skilled in the art would be able to determine how to best treat the microspheres with an adhesion promoter.

In some embodiments, the binder resin layer is selected from at least one of linear resins and resins having low cross link densities. In some embodiments, the binder resin layer is selected from at least one of the following linear materials: polyurethanes, polyureas, polyurethane ureas, polyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof.

In some embodiments, the binder resin layer includes a condensation polymer or an acrylic polymer. In some embodiments, the binder resin layer includes a fluorine-containing organic polymeric material and the major textured surface has microspheres that are partially embedded in the first major surface of the binder resin layer and adhered thereto. The binder resin layer should exhibit good adhesion to the microspheres themselves or to the treated microspheres. It is also possible that an adhesion promoter for the microspheres could be added directly to the binder resin layer itself as long as it is compatible within the process window for disposing the binder resin layer on the surfaces of the microspheres. It is important that the binder resin layer has sufficient release from the thermoplastic release layer of the transfer carrier to allow removal of the transfer carrier from the microspheres, which are embedded on one side in the thermoplastic release layer and on the other side in the binder resin layer.

The binder resin layer of the present disclosure is selected such that the resulting articles exhibit stain resistance to yellow mustard at elevated temperature and humidity. The binder resin is also selected to have capability for covalent bonding to the microspheres and the microspheres may be designed to have functionality reactive to the binder resin. In one aspect, the microspheres are functionalized with aminosilanes with the silane bonding to the glass microsphere producing a pendent amine. As amines are strong nucleophiles, the choice of binder resins containing isocyanate functionality provides a simple and fast reaction to form a urea linkage connecting the beads covalently to the binder resin.

In some embodiments, the binder resin is also selected to have pendent hydroxyl groups for reaction with polyisocyanates to build molecular weight through condensation polymerization. The binder resin is also selected to have free radically polymerizable functionality such as (meth)acrylate groups, so that the presently disclosed materials may be thermoformed and then free radically crosslinked to make a thermoset article. As a result, the surface of the thermoset article becomes more rigid leading to higher pencil hardness values and more crosslinked so that solvents and staining agents are less able to penetrate the surface. The selection of binder resins with fluorine in the backbone in combination with the free radical crosslinking leads to resistance to staining by mustard and other colored staining agents.

Fluorine-containing polymers are useful in the presently disclosed binder resin layer to exhibit desirable stain and solvent resistance characteristics because they include fluorine-containing polymers that are partially fluorinated polymers derived from two or more non-fluorinated monomers having at least one functional group, where at least one but not all of the functional groups are reacted with at least one curing agent having latent functionality. In some embodiments, the at least one partially fluorinated, or non-fluorinated, monomer is a fluorinated polyhydroxy-containing polymer. In some embodiments, the at least one partially fluorinated, or non-fluorinated, monomer has a number molecular weight of greater than or equal to 9000 g/mol.

In some embodiments, this may be calculated by taking into account both the weight ratios of the monomers included, as well as the fluorine content by weight of each monomer along its polymerizable chain length, including fluorine atoms that are present on those atoms once removed from the polymerizable chain. As an example, a copolymer of tetrafluoroethylene, hexafluoropropylene, and vinylidene fluoride in a weight ratio of 10:40:50 would have a backbone fluorine content of 67.7%. In some embodiments, this can be calculated as follows.

Tetrafluoroethylene: C2F2, molecular weight 100.01, monomeric fluorine content 76.0%, weight ratio 10%;

Hexafluoropropylene: C3F6, molecular weight 150.02, monomeric fluorine content 76.0%, weight ratio 40%;

Vinylidene fluoride: C2H2F2, molecular weight 64.03, monomeric fluorine content 59.3%, weight ratio 50%.

(0.1×0.76)+(0.4×0.76)+(0.5×0.593)]×100=67.7%.

Note that this calculation includes the fluorine atoms on the trifluoromethyl group of hexafluoropropylene since it is only one atom removed from the polymerizable chain of the hexafluoropropylene monomer.

In some embodiments of the present disclosure the fluorine content along the polymeric backbone of the fluorine-containing polymer is from about 25% to about 72% by weight.

Although there may be fluorine-containing materials which possess the desired fluorine content they may not exhibit the desired level of stain resistance to highly staining materials, such as yellow mustard, at elevated temperature and humidity. Without wishing to be bound by theory, it is believed that those materials in which the fluorine atoms reside solely, or predominately, in pendent side chains or end group do not exhibit the desired stain resistance characteristics of the articles of the present disclosure. While materials in which the fluorine atoms reside solely, or predominately, in pendent side chains or end group may provide adequate stain resistance to yellow mustard at room temperature and humidity they have been found to not do so at elevated temperature and humidity.

The fluorine-containing polymer of the binder resin is desirably coatable out of solvent or from an aqueous dispersion. Use of solvent coating or aqueous dispersions provides advantages such as lower processing temperatures which in turn permits the use of materials such as polyethylene in the transfer carrier. Lower process temperatures also generally result in decreased thermal stress in the final articles. In addition, the use of certain higher boiling solvents may advantageously provide articles with reduced amounts of entrapped air in the dried and cured binder resin layer.

In addition to being coatable from solvent or aqueous dispersions, the fluorine-containing materials of the binder resin layer desirably form a continuous film upon drying. Without being bound by theory, it is believed that film continuity, i.e., free of pinholes and other discontinuities, contributes to the resistance of the articles of the present disclosure to highly staining materials such as yellow mustard, blood, wine, etc. It is also believed that such film continuity contributes to enhanced mechanical properties as well as improving texture transfer from the transfer carrier to the binder resin layer.

Binder resins useful in the binder resin layer include partially fluorinated polymers derived from two or more non-fluorinated monomers having at least one functional group, where at least one but not all the functional groups are reacted with at least one curing agent having latent functionality.

CN 101314684 and CN 101319113, for example, disclose ZEFFLE GK 570 as having a fluorine content of 35-40%. JP 2010182862, for example, discloses ZEFFLE GK 570 as having a fluorine content of 35%. The forgoing documents are incorporated herein by reference in their entirety.

Chlorotrifluoroethylene (CTFE) polyhydroxy containing polymers may also be useful in the present invention. Exemplary CTFE polyhydroxy containing polymers include those available under the trade designation LUMIFLON from Asahi Glass Chemicals American, Bayonne, N.J.

In some embodiments, the binder resin may include nonfluorinated polyols in addition to fluorinated polyols, as long as they are miscible in solution and in the dried and cured products. The binder resin may include monoalcohols, in limited amounts. The monoalcohol may also possess latent functionality, such as acrylate groups (e.g. hydroxyethylacrylate), or be fluorinated to enhance chemical resistance (e.g. N-methyl, N-butanol perfluorobutanesulfonamide).

For the presently disclosed articles to be stain resistant and thermoformable, it is preferred that the fluorine-containing polymer in the binder resin layer has at least one partially fluorinated, or non-fluorinated, monomer that is reacted with at least one curing agent having latent functionality.

In some embodiments, the binder resin layer comprises an aliphatic polyurethane polymer comprising a plurality of soft segments, and a plurality of hard segments, wherein the soft segments comprise polycarbonate polyol, poly(alkoxy) polyol, or combinations thereof.

The binder resin layer may be transparent, translucent, or opaque. The binder resin layer may, for example, be clear and colorless or pigmented with opaque, transparent, or translucent dyes and/or pigments. In some embodiments, inclusion of specialty pigments, such as for example metallic flake pigments, can be useful.

The binder resin may also include additional free radically curable additives, including acrylate functional monomers and acrylate functional polymers.

In some embodiments the binder resin layer is typically formed on a textured transfer carrier after transparent microspheres have been partially embedded in the release layer of the transfer carrier. The binder resin layer is typically coated over the textured transfer carrier by a direct coating process but could also be provided over the textured transfer carrier via thermal lamination either from a separate carrier or by first forming the binder resin layer on a separate substrate from which it is subsequently transferred to cover the textured transfer carrier.

In some embodiments the binder resin layer is continuous such that there is no break either in the areas between, or beneath, the microspheres in the articles of the present disclosure. In another embodiment, the binder resin layer is continuous in the areas between the microspheres, although it may not be present beneath the microspheres in the articles of the present disclosure.

The presently disclosed articles can optionally comprise one or more reinforcing layer(s). Examples of suitable reinforcing layers include polyurethane resin systems, acrylic resin, polyester resins, epoxy resins, and combinations thereof. Suitable polyurethane resin systems include, but are not limited to, those selected from at least one of polyurethane dispersions, two part urethanes coated from solvent, 100% solids two part urethanes, and combinations thereof. Suitable acrylic resin systems include, but are not limited to, those selected from UV-curable acrylic resin systems, or thermally curable acrylic resin systems. Such systems may be solvent coated, aqueous dispersions, or hot melt coated. One suitable type of polyester resin are co-amorphous polyester resins. Suitable epoxy resin systems include, but are not limited to, those selected from at least one of two part and one part epoxy resins. Such reinforcing layers may be formed on the surface of the binder resin layer opposite that of the texture-containing transfer carrier. The reinforcing layer can serve to provide advantageous handling characteristics, and in doing so permit the use of thinner layers of binder resin.

The presently disclosed articles can optionally comprise one or more substrate layer(s). Examples of suitable substrate layers include but are not limited to those selected from at least one of fabrics (including synthetics, non-synthetics, woven and non-woven such as nylon, polyester, etc.), polymer coated fabrics such as vinyl coated fabrics, polyurethane coated fabrics, etc.; polymeric matrix composites; leather; metal; paint coated metal; paper; polymeric films or sheets such as acrylics, polycarbonate, polyurethanes such as thermoplastic polyurethanes, polyesters including amorphous or semi-crystalline polyesters such as polyethylene terephthalate, elastomers such as natural and synthetic rubber, and the like. The substrates may, for example, be in the form of a clothing article; automobile, marine, or other vehicle seat coverings; automobile, marine, or other vehicle bodies; orthopedic devices; electronic devices, hand held devices, household appliances, and the like.

The present disclosure also provides articles which are thermoformable or stretchable. In order for the article to be thermoformable or stretchable, the materials in the article must have certain properties.

First, when the article is formed, the article must retain its formed dimensions. If the article has high elasticity, it can recover when the forming stresses are removed, essentially undoing the forming step. Therefore, high elasticity can be problematic. This issue can be avoided by using materials that undergo melt flow at or near the forming or stretching temperature. In other cases, a component of the article can have elasticity at the forming temperature, but this elasticity is likely to exert a recovery force after forming. To prevent this elastic recovery, the elastic layer can be laminated with a material that does not show this elasticity. For example, this inelastic material can be a thermoplastic material.

The other criterion for the article to be formable is that it can bear the elongation that occurs during forming or stretching without failing, cracking, or generating other defects. This can be achieved by using materials that have a temperature at which they undergo melt flow and conducting the forming step near that temperature. In some cases, crosslinked materials that do not flow can be used, but they are more likely to crack during the elongation. To avoid this cracking, the crosslink density should be kept low, as can be indicated by a low storage modulus in the rubbery plateau region. The expected degree of crosslinking can also approximated as the inverse of the average molecular weight per crosslink, which can be calculated based on the components of a material. In addition, it is preferred to do the forming at relatively low temperatures, since as temperatures increase above the glass transition temperature of crosslinked materials, their capacity for elongation begins to decrease.

Thermoformable materials suitable for use in articles of the present disclosure include polycarbonate, polyurethanes such as thermoplastic polyurethanes, and polyesters including amorphous or semi-crystalline polyesters such as polyethylene terephthalate.

The present disclosed binder resin layer can optionally also perform the function of acting as the adhesive for a desired substrate and/or further comprise pigment(s) such that it also has a graphic function.

The binder resin layer, when selected to function also as a substrate adhesive graphic image, may be, for example, pigmented and provided in the form of an image, such as, for example, by screen printing the binder resin in the form of a graphic for transfer to a separate substrate. However, the binder resin layer, in some instances, is preferably colorless and transparent so that it can allow transmission of color from either a substrate, separate graphic layers (discontinuous colored polymeric layers) placed below it, or from a separate substrate adhesive that is optionally colored and optionally printed in the form of a graphic image (a discontinuous layer).

Typically, if a graphic image is desired it is provided separately on the surface of the binder resin layer opposite the major textured surface by at least one colored polymeric layer. The optional colored polymeric layer may, for example, comprise an ink. Examples of suitable inks for use in the present disclosure include but are not limited to those selected from at least one of pigmented vinyl polymers and vinyl copolymers, acrylic and methacrylic copolymers, urethane polymers and copolymers, copolymers of ethylene with acrylic acid, methacrylic acid and their metallic salts, and blends thereof. The colored polymeric layer, which can be an ink, can be printed via a range of methods including, but not limited to screen printing, flexographic printing, offset printing, lithography, transfer electrophotography, transfer foil, and direct or transfer xerography. The colored polymeric layer may be transparent, opaque, or translucent.

A colored polymeric layer(s) may be included in the articles of the present disclosure by a number of procedures. For example, a transfer carrier can have a layer of transparent microspheres embedded in the release layer thereof, following which the microsphere embedded surface of the release layer is coated with a transparent layer of binder. This microsphere and adhesive coated transfer carrier can function as a casting liner by coating, for example, a continuous colored plasticized vinyl layer over the binder resin layer and wet laminating a woven or non-woven fabric thereover.

Another method involves providing graphic layers (discontinuous colored polymeric layers, for example) on the binder resin layer prior to casting a continuous colored plasticized vinyl layer to approximate the image of leather, for example.

The presently disclosed articles may each optionally further comprise one or more adhesive layers. A substrate adhesive layer, for example, may optionally be included in the article in order to provide a means for bonding the binder layer or the layer(s) of material optionally bonded to the binder layers to a substrate. A substrate adhesive layer (as well as any other optional adhesive layers) may be selected from those generally known in the art such as, for example, pressure sensitive adhesives, moisture curing adhesives, and hot melt adhesives (i.e. those applied at elevated temperatures). Examples of such materials, include, for example, (meth)acrylics, natural and synthetic rubbers including block copolymers, silicones, urethanes, and the like. However, each adhesive layer used must be selected such that it will adhere the desired layers together. For example, a substrate adhesive layer must be selected such that it can adhere to an intended substrate as well as to the other layer to which it is bonded.

The optional adhesive layer, when present, may be continuous in some embodiments or discontinuous in some embodiments. Typically, the substrate layer, when present, is continuous, although it may be discontinuous. By continuous it is meant that within the outermost boundaries of the adhesive layer there are no areas left uncovered by the adhesive layer. Discontinuous means there may be areas present that are not covered by the adhesive layer. Such adhesive layers may be disposed on a surface opposite that of the first major surface of the binder resin layer.

In the articles of the present disclosure the substrate layers, graphic layers, and adhesive layers, when present, may be disposed on a surface other than the first major surface of the binder resin layer. For example, such articles may comprise a binder resin layer having a first and second major surface, a plurality of microspheres partially embedded in, and adhered thereto, the first major surface of the binder resin layer, a reinforcing layer having a first and second major surface which is formed with its' first major surface in contact with the second major surface of the binder resin layer, an adhesive layer having a first and second major surface with its' first major surface in contact with the second major surface of the reinforcing layer, and a substrate layer having a first and second major surface with its' first major surface in contact with the second major surface of the adhesive layer. Alternatively, the adhesive layer may be absent and the first major surface of the substrate layer may be in contact with the second major surface of the reinforcing layer.

In some embodiments, the present disclosure provides decorative compliant articles comprising a binder resin; and a plurality of microspheres partially embedded and adhered to a major surface of the binder resin layer, where the article has a compression modulus of less than or equal to 0.5 MPa. In some embodiments, the thickness of the compliant article is greater than 50 micrometers.

In some embodiments, it is preferred that the article is thermoformable or stretchable. In order for the article to be thermoformable or stretchable, the materials in the article, such as the compliant article, must have certain properties. An exemplary test method for determining the stretchability is included in the tensile test conducted according to ASTM D882-10. In some embodiments, it is preferable that the article is free of visual defects, such as for example inhomogeneities (bubbles, dark spots, light spots, and the like).

The other criterion for the article to be formable is that it can bear the elongation that occurs during forming or stretching without failing, cracking, or generating other defects. This can be achieved by using materials that have a temperature at which they undergo melt flow and forming near that temperature. Techniques for determining low cross link density can be found in WO 2014/055828 A1, which is incorporated herein by reference in its entirety. In some cases, crosslinked materials that do not flow can be used, but they are more likely to crack during the elongation. To avoid this cracking, the crosslink density should be kept low, as can be indicated by a low storage modulus in the rubbery plateau region. The expected degree of crosslinking can also approximated as the inverse of the average molecular weight per crosslink, which can be calculated based on the components of a material. In addition, in some embodiments forming can be conducted at relatively low temperatures, since as temperatures increase above the glass transition temperature of crosslinked materials, their capacity for elongation begins to decrease. For example, in some embodiments, the article has an elongation percent at failure of greater than 26%.

Premasks are protective films that may be coated or laminated to other high value products or devices to preserve the appearance and cleanliness of the products. In some cases these are removed by an end customer, in other instances they are present in intermediates and removed prior to device manufacture. Sprayable, tapes, coatable premasks, or combinations thereof can be used to protect the presently disclosed textured surfaces.

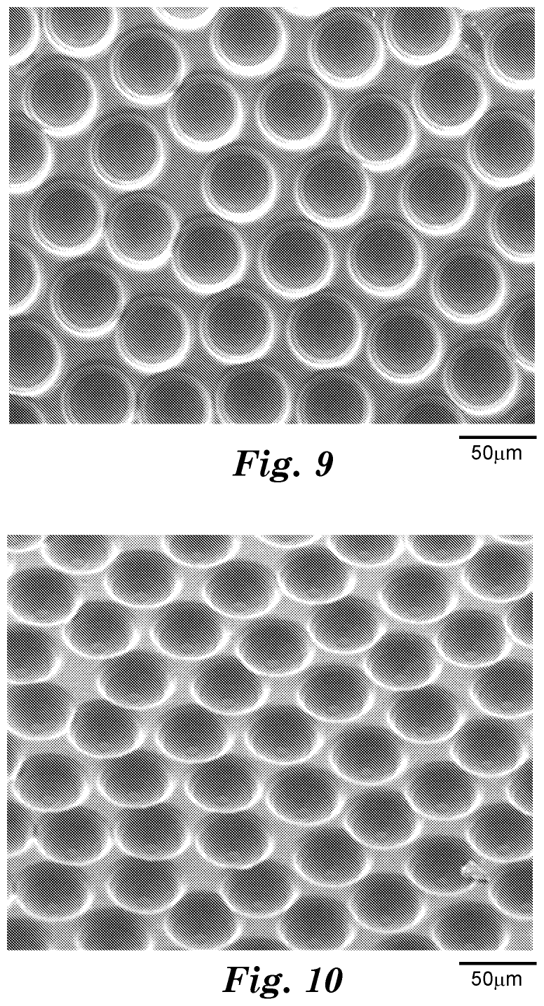

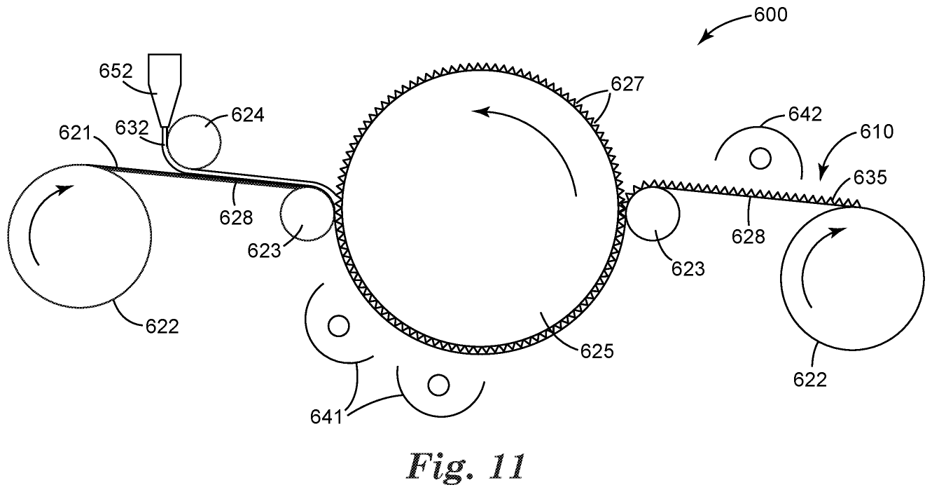

The textured surface can be made using different approaches, for example, a molding process. In one example approach, the textured surface can be made using a molding tool with a micro-replicated cavities surface illustrated in FIG. 9, in a schematic representation of the process illustrated in FIG. 11, and produce an article with a portion of surface illustrated in FIG. 10. FIG. 11 shows an exemplary embodiment of apparatus 600 having roll 625 with ellipsoidal cavities 627 in the surface of roll 625. A radiation curable resin 632 is coated from die 652 onto light transmissive support layer 621 coming from supply roll 622, along with optional light transmissive carrier film 628. The radiation curable resin 632 on light transmissive support layer 621 is pressed into contact with the surface of roll 625 with nip roll 623, passes first irradiation source 641, forming ellipsoidal protrusions 635 adhered to light transmissive support layer 621. The ellipsoidal protrusions 635 on support layer 621 are de-molded from roll 625, and then pass post-cure irradiation source 642, completing formation of textured article 610 having ellipsoidal protrusions 635, which for convenience is wound onto a take-up roll.

Test Methods

Surface Profilometry Measurements

Roughness parameters used to describe a textured surface were determined by making measurements of the entire surface topography using the following steps.

1. Collection of Surface Topography

Topographic measurements were made using a Stylus Profilometer, Dektak 8 (available from Bruker Corporation, Tucson, Ariz.) using a 2.5 micrometer radius tip and 2 milligrams of force. The topographical maps generated were composed of 361 line scans spread equally over 2 millimeters in the y-scan direction. Each line was 2 millimeters long in the x-scan direction and included 6000 data points. Samples were at least 1 centimeter square, without rough edges and mounted on microscopy slides, with double-sided permanent adhesive tape.

2. Initial Processing of Surface Topography

An x-average filter was applied to the profilometry data collected in step 1 to remove small variations in the z-position between sequential scan lines. Then a tilt-removal operation was performed to level the topographic map, and the processed map was saved.

3. Determination of Top Surface Envelope

The data from step 2 was analyzed using the following routines in MATLAB software (MathWorks, Incorporated, Natick, Mass.).

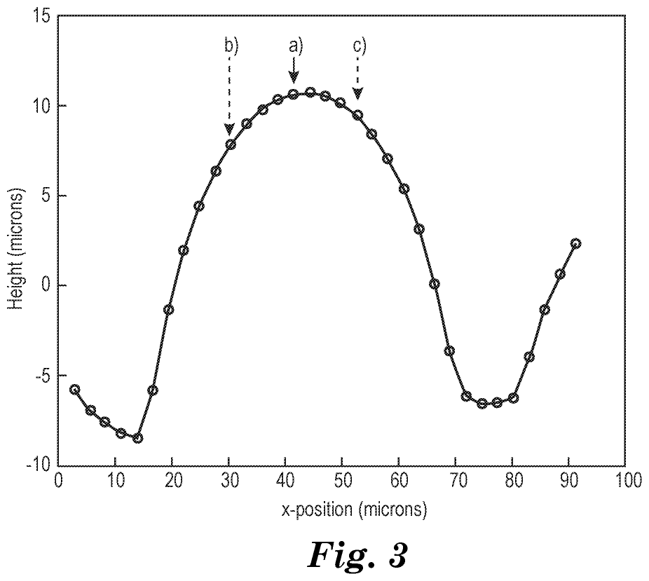

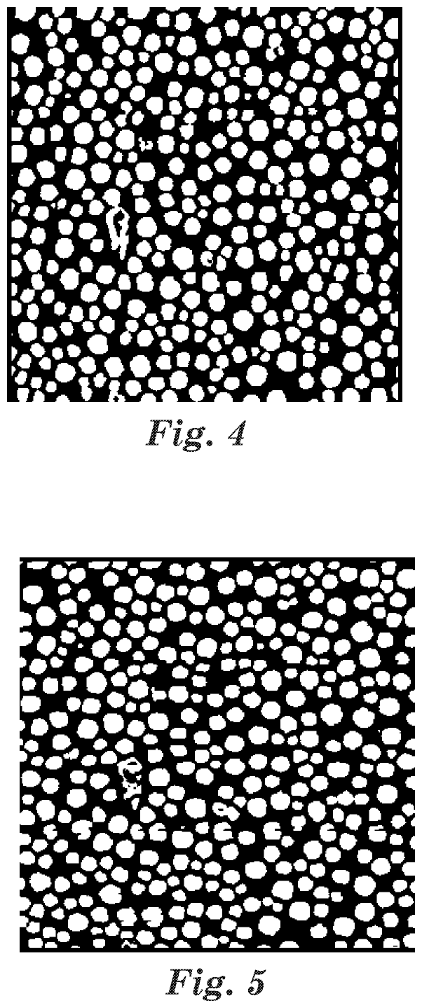

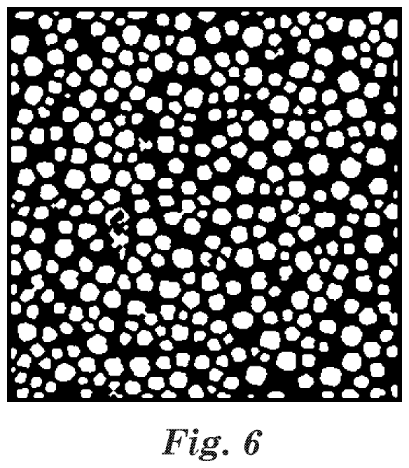

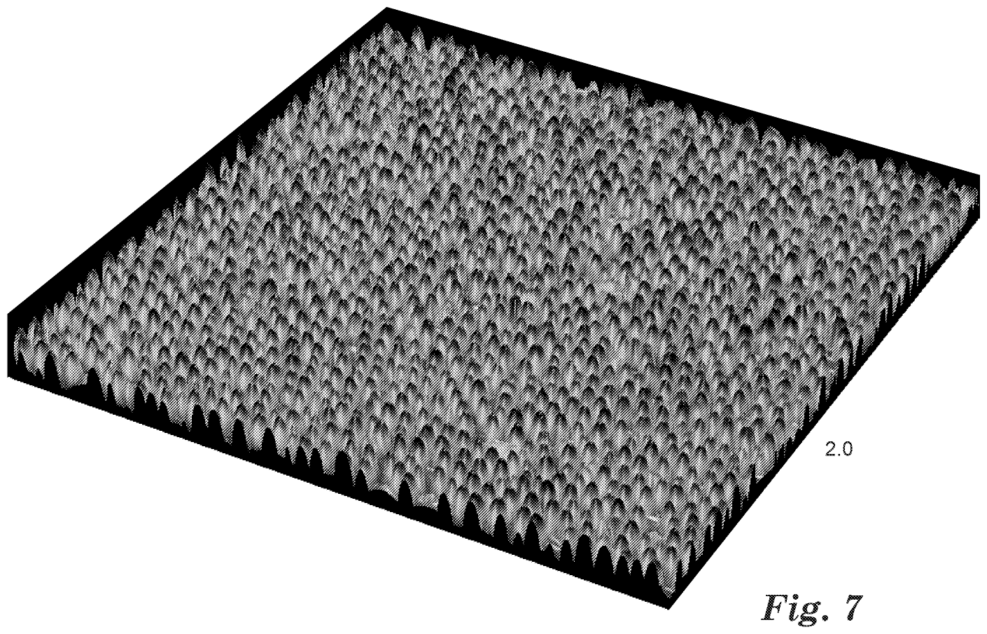

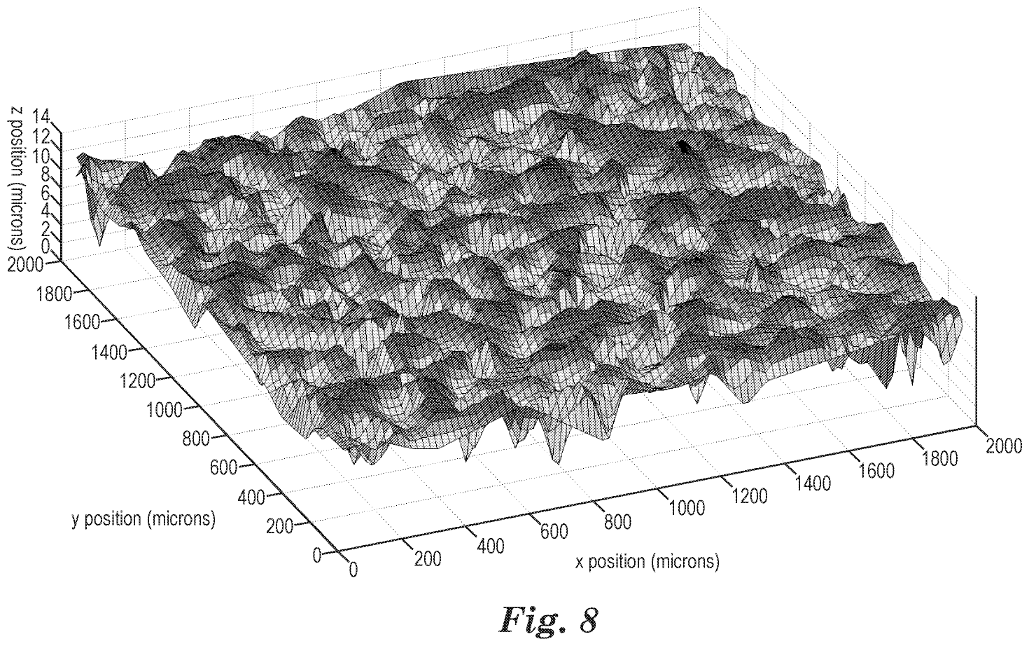

a. Rescale Data
A bicubic interpolation method, imresize.m was applied to the maps to provide equal aspect ratio data points.
   b. Subdivided Topographic Map
The 2 millimeter×2 millimeter map was divided into four 1 millimeter×1 millimeter submaps for further analysis.
   c. Calculate Surface Curvature Map
A surface curvature map was generated as follows.
   1. The curvature is measured over approximately within 10 micrometers on either side of each pixel. This is illustrated in FIG. 2 where the pixel of interest is point a), and the curvature is calculated between points b) and c).
   2. After the curvature for a pixel is calculated, two conditions were applied: a) was the curvature less than −0.002 l/micrometers (the negative sign indicating the curvature is downwards, and the absolute radius of curvature less than 500 micrometers), and b) was the pixel above the mean plane of the surface topography. Satisfying these two conditions indicated that the pixel was near the top of a feature and thus exposed to contact by a user. This measurement was performed in both the x- and y-directions (FIGS. 3 and 4), and the combined map of the two curvature maps was determined (where each pixel satisfied the height condition, and the curvature condition in each direction).
   3. Image processing was performed first using median filtering, with a 3 pixels by 3 pixels window, followed by a morphological open (disk radius=1 pixel) and then a morphological close (line length of 3 pixels, oriented in the y-direction) to remove artifacts such as the row indicated by the arrow in FIG. 4).
   4. The individual features identified were then further analyzed according to steps 5-7 below.
      d. Calculate the Top Surface Envelope
For each image feature found in the previous step, the position (in x, y and z) of the highest point was found by performing a search of the topography data within the binary mask shown in FIG. 5. This array of points was used to define the top surface envelope. The top surface envelope was visualized by creating a regular mesh describing the surface from the array of data points, using the MATLAB routine TriScatteredInterp.m. as illustrated in FIG. 8 which corresponds to the textured surface as illustrated in FIG. 7.

4. Analysis of Top Surface Envelope

Conventional roughness parameters were used to analyze the envelope surface as described in Table 2.

TABLE 2

| Parameter | Definition | Notes |
|---|---|---|
| Envelope Rq | $R q = \sqrt{\frac{{\sum }_{i = 1}^{n} {( {Z}_{i} - \overline{Z} )}^{2}}{n}}$ | The RMS roughness, or the standard deviation of the height values of the surface envelope defined by the tops of the protrusions |
| Envelope Rp | Rp = max(Z) − mean(Z) | Maximum Peak Height. The height difference |
| | | between the mean of the surface defined by the tops |
| | | of all the protrusions and the top of the highest |
| | | protrusion in the evaluation region (here a 1 |
| | | millimeter × 1 millimeter evaluation area). |

5. Analysis of Individual Features

The characteristics of individual features were then determined. First, the radius of curvature of each feature was calculated from the topographic map. The method involved finding the curvature of the feature at its highest point, as this location was most exposed to a user's fingertip. The curvature was calculated at the highest point on the feature as well as the 8 nearest neighbor pixels. For irregular features, the highest point of the feature was sometimes at the edge of the feature, and so some of the nearest neighbor pixels are not on the feature. To accommodate this, only the pixels located on the feature were included (the binary map shown in FIG. 5 is used as a mask to determine valid points). The mean of the curvature of all valid pixels at and near the highest point was reported as the curvature, and the reciprocal of the mean local curvature was reported as the radius of curvature for that feature. Negative numbers indicated that the features were curved downwards. As the radius of curvature (RoC) approached zero, the sharper the feature was. The parameters Rt and Sm (defined in Table 3) were computed using x-stylus analyses performed in Vision Software (available from Bruker Corporation, Tucson, Ariz.) where every line in the map was analyzed and the mean value was reported. In each case, each line was subdivided into 5 sublengths and analyzed.

TABLE 3

| Parameter | Notes |
|---|---|
| RoC sharp | Radius of curvature of the sharpest feature in the evaluation region (here a 1 |
| | millimeter × 1 millimeter evaluation area). The smaller the radius of curvature, |
| | the sharper the feature. This reports the sharpest feature in the evaluation area |
| Rt | Peak to valley difference calculated over an evaluation length. Each scan line (in |
| | the x-direction) in the map is sub-divided into 5 evaluation lengths and the values |
| | are averaged for each line and then averaged for all lines. |
| Sm | Mean peak spacing: mean spacing between profile peaks at the mean line, |
| | measured over the evaluation length. A profile peak is the highest point on the |
| | profile between an upwards and downwards crossing of the profile of the mean line. |

6. Analysis of Feature Spacing

Feature spacing was determined by counting the number of features/square millimeter area as determined in step 5 and shown in FIG. 5.

7. Analysis of Irregular Features

Irregular features were measured using MATLAB software. First, the area of the image feature (defined as the portion of a protrusion with height within 5 micrometers of the peak of the protrusion) was measured using the MATLAB routine regionprops.m. Then, the perimeter of the image feature was measured. The metric of regularity was defined as the ratio of the image feature area to the area calculated for a hemisphere of the same perimeter (for an ellipsoid, the major and minor axes lengths obtained with regionprops.m were used). The metric of regularity was defined as being 1 for a perfectly regular ellipsoid. A metric below 0.85 or above 1.15 is indicative of an irregular shaped feature. The image features which are touching the edges of the measured area were ignored since they represent incomplete features. The number fraction of irregular features was defined as the ratio of the number of irregular shaped protrusions to the total number of protrusions in the sampling area. The area fraction of irregular features was defined as the ratio of the total area of irregular shaped protrusions to the total area of all protrusions in the sampling area. The total sampling area was 1 millimeter×1 millimeter.

Haptic (Touch) Perception Test

Test materials were selected from those used in personal electronic devices, such as computer touchpads, cell phones, tablets (e.g. KINDLE FIRE), and casings. Eleven participants were selected to evaluate the surfaces of each of the test material by touch, also referred to as haptic evaluation. The participants were not involved with the development work included in the present disclosure. The participants demographically comprised 5 males and 6 females, ranging in age from 22 to 61 years old with an average age of 35 years old. Prior to testing, each of the test materials was cleaned with rubbing alcohol and lint free paper tissues to remove any surface debris and skin oils. In addition, the participants cleaned their hands in the same manner approximately 5 to 10 minutes before the evaluations were begun. The test materials used were kept in an incubator set to 28° C. (82° F.) at least two hours prior to testing, then removed and immediately haptically evaluated. Upon completion of the evaluation the test materials were returned to the incubator and kept there until further testing. The temperature of the testing environment was 22° C. (72° F.). The test materials were rated on a scale of 0 (least desirable) to 10 (most desirable) with respect to each participant's preference of what an ideal tracking surface, such as a trackpad, should feel like.

Each test material, measuring 5.1 centimeters wide by 10.2 centimeters long (2 inches by 4 inches), was adhered to an acrylic substrate having the same dimensions and a thickness of 0.5 centimeters thick (0.2 inches) using an adhesive transfer tape to bond the test material to the substrate, thereby providing each individual test specimen. The test specimen were placed in a holder to prevent sliding and the holder was provided with a gripping surface on the bottom. A box-like enclosure, measuring 39.5 centimeters wide by 38 centimeters high by 45.5 centimeters deep (15.6 inches by 15.0 inches by 17.9 inches), was placed over the holder/test specimen. The enclosure was partially open along its' bottom edge on one side to permit the participants to place their hands on, and feel, the surface of each of the test specimen while preventing them from seeing the materials. This opening extended across the entire width and had a height of 18.5 centimeters (7.3 inches). On the opposite side from this opening the entire surface was removed to permit exchange of the different test specimens and recording by an observer of the preference ratings. The participants were equipped sound dampening 3M ear plugs to prevent them from receiving any potential audio information about the test specimen surfaces during handling.

Participants were initially allowed to handle and rate six different test specimens one time each in a random order so they could become familiar with the testing process. These results were discarded. The participants then proceeded to handle and rate these six different test specimens in a random order such that each test specimen was evaluated a total of three times. The average for each participant was calculated, and these individual averages were used to determine the overall average rating for Preference. The overall average and the standard error are reported in Table 6.

### EXEMPLARY EMBODIMENTS

Embodiment A1. An article comprising: a major textured surface having a plurality of ellipsoidal protrusions, wherein the plurality of ellipsoidal protrusions is disposed in repeated units, and wherein each of the repeated units has a pseudorandom pattern, such that a spatial FFT spectrum of the pseudorandom pattern has one or more rings and has a relatively high spectral energy proximate to the one or more rings and relatively low spectral energy away from the one or more rings.

Embodiment A2. The article of Embodiment A1, wherein a degree of short range regularity of the pseudorandom pattern is greater than 0.7 and a degree of long range regularity of the pseudorandom pattern is less than 0.5.

Embodiment A3. The article of Embodiment A1 or A2, wherein the degree of short range regularity is the normalized nearest neighbor distance coefficient of variation minus by one.

Embodiment A4. The article of Embodiment A3, wherein the normalization is performed using the nearest neighbor distance coefficient of variation for a random map with the same feature density as the article.

Embodiment A5. The article of any of Embodiments A1-A4, wherein the degree of long range regularity is the normalized azimuth angle coefficient of variation.

Embodiment A6. The article of Embodiment A4, wherein the normalization is performed using the azimuth angle coefficient of variation for a regular map with the same feature density as the article.

Embodiment A7. The article of any of Embodiments A1-A6, wherein the major textured surface has an envelope Rq of less than 2.25 micrometers, an envelope Rp of less than 5.5 micrometers and an Rt of greater than 10 micrometers.

Embodiment A8. The article of any of Embodiments A1-A7, wherein the textured surface has a perception preference rating greater than or equal to 7.25.

Embodiment A9. The article of Embodiment A1 wherein the textured surface has a perception preference rating between 6.40 and 10.00.

Embodiment A10. The article of any of Embodiments A1-A9, wherein the textured surface has a RoC sharp of greater than or equal to 3.2 micrometers.

Embodiment A11. The article of any of Embodiments A1-A10, further comprising at least some smooth surface domains within the major textured surface.

Embodiment A12. The article of any of Embodiments A1-A11, wherein the textured surface has an area percent of less than 7.5% of irregular shaped protrusions based on the area occupied by all protrusions.

Embodiment A13. The article of any of Embodiments A1-A12, wherein the textured surface comprises ellipsoidal protrusions that are about 10 to 75 micrometers wide.

Embodiment A14. The article of any of Embodiments A1-A13, wherein the centers of the ellipsoidal protrusions are a distance of about 25 to 100 micrometers from each other.

Embodiment A15. The article of any of Embodiments A1-A14, wherein the textured surface comprises between about 200 and 1000 ellipsoidal protrusions per square millimeter.

Embodiment A16. The article of any of Embodiments A1-A15, wherein the ellipsoidal protrusions have an aspect ratio of between 1 and 1.49.

Embodiment A17. The article of any of Embodiments A1-A16, wherein the ellipsoidal protrusions are hemispherical.

Embodiment A18. The article of any of Embodiments A1-A17, wherein the ellipsoidal protrusions are microspheres.

Embodiment A19. The article of any of Embodiments A1-A18, wherein the microspheres comprise less than 3 wt % of irregular shaped particles.

Embodiment A20. The article of any of Embodiments A1-A19, wherein the ellipsoidal protrusions are disposed on a first major surface of a binder resin layer.

Embodiment A21. The article of Embodiment A20 wherein the plurality of ellipsoidal protrusions comprise a plurality of microspheres partially embedded and adhered to the first major surface of the binder resin layer.

Embodiment A22. The article of Embodiment A21, wherein the article is a compliant article.

Embodiment A23. The article of Embodiment A21, wherein the binder resin layer comprises an aliphatic polyurethane polymer comprising a plurality of soft segments, and a plurality of hard segments, wherein the soft segments comprise polycarbonate polyol, poly(alkoxy) polyol, or combinations thereof.

Embodiment A24. The article of Embodiment A21, wherein the plurality of microspheres are transparent microspheres having refractive indices that are less than 1.55.

Embodiment A25. The article of Embodiment A21, wherein the binder resin layer is selected from at least one of linear resins and resins having low cross link densities.

Embodiment A26. The article of Embodiment A21, wherein the binder resin layer comprises a fluorine-containing polymer, and wherein the fluorine-containing polymer is derived in part from at least one partially fluorinated, or non-fluorinated, monomer.

Embodiment A27. The article of any of Embodiments A18, A19 and A21-A26, wherein the plurality of microspheres are selected from at least one of glass, polymers, glass ceramics, ceramics, metals and combinations thereof.

Embodiment A28. The article of any of the Embodiments A20-A27, wherein the binder resin layer is selected from at least one of the following linear materials: polyurethanes, polyureas, polyurethane ureas, polyesters, polycarbonate, ABS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof.

Embodiment A29. The article of any of the Embodiments A1-A28, wherein the article is a film.

Embodiment A30. The article of any of Embodiments A1-A29, wherein a feature density of the article is in a range of 200 to 1000 per square millimeter.

Embodiment B1. An article comprising: a major textured surface having a plurality of ellipsoidal protrusions, wherein the plurality of ellipsoidal protrusions is disposed in repeated units, and wherein each of the repeated units has a pseudorandom pattern, such that is a degree of short range regularity of the pseudorandom pattern is greater than 0.7 and a degree of long range regularity of the pseudorandom pattern is less than 0.5.

Embodiment B2. The article of Embodiment B1, wherein a spatial FFT spectrum of the pseudorandom pattern has one or more rings and has a relatively high spectral energy proximate to the one or more rings and relatively low spectral energy away from the one or more rings.

Embodiment B3. The article of Embodiment B1 or B2, wherein the degree of short range regularity is the normalized nearest neighbor distance coefficient of variation minus by one.

Embodiment B4. The article of Embodiment B3, wherein the normalization is performed using the nearest neighbor distance coefficient of variation for a random map with the same feature density as the article.

Embodiment B5. The article of any of Embodiments B1-B4, wherein the degree of long range regularity is the normalized azimuth angle coefficient of variation.

Embodiment B6. The article of Embodiment B4, wherein the normalization is performed using the azimuth angle coefficient of variation for a regular map with the same feature density as the article.

Embodiment B7. The article of any of Embodiments B1-B6, wherein the major textured surface has an envelope Rq of less than 2.25 micrometers, an envelope Rp of less than 5.5 micrometers and an Rt of greater than 10 micrometers.

Embodiment B8. The article of any of Embodiments B1-B7, wherein the textured surface has a perception preference rating greater than or equal to 7.25.

Embodiment B9. The article of Embodiment B1 wherein the textured surface has a perception preference rating between 6.40 and 10.00.

Embodiment B10. The article of any of Embodiments B1-B9, wherein the textured surface has a RoC sharp of greater than or equal to 3.2 micrometers.

Embodiment B11. The article of any of Embodiments B1-B10, further comprising at least some smooth surface domains within the major textured surface.

Embodiment B12. The article of any of Embodiments B1-B11, wherein the textured surface has an area percent of less than 7.5% of irregular shaped protrusions based on the area occupied by all protrusions.

Embodiment B13. The article of any of Embodiments B1-B12, wherein the textured surface comprises ellipsoidal protrusions that are about 10 to 75 micrometers wide.

Embodiment B14. The article of any of Embodiments B1-B13, wherein the centers of the ellipsoidal protrusions are a distance of 25 to 100 micrometers from each other.

Embodiment B15. The article of any of Embodiments B1-B14, wherein the textured surface comprises between about 200 and 1000 ellipsoidal protrusions per square millimeter.

Embodiment B16. The article of any of Embodiments B1-B15, wherein the ellipsoidal protrusions have an aspect ratio of between 1 and 1.49.

Embodiment B17. The article of any of Embodiments B1-B16, wherein the ellipsoidal protrusions are hemispherical.

Embodiment B18. The article of any of Embodiments B1-B17, wherein the ellipsoidal protrusions are microspheres.

Embodiment B19. The article of any of Embodiments B1-B18, wherein the microspheres comprise less than 3 wt % of irregular shaped particles.

Embodiment B20. The article of any of Embodiments B1-B19, wherein the ellipsoidal protrusions are disposed on a first major surface of a binder resin layer.

Embodiment B21. The article of Embodiment B20 wherein the plurality of ellipsoidal protrusions comprise a plurality of microspheres partially embedded and adhered to the first major surface of the binder resin layer.

Embodiment B22. The article of Embodiment B21, wherein the article is a compliant article.

Embodiment B23. The article of Embodiment B21, wherein the binder resin layer comprises an aliphatic polyurethane polymer comprising a plurality of soft segments, and a plurality of hard segments, wherein the soft segments comprise polycarbonate polyol, poly(alkoxy) polyol, or combinations thereof.

Embodiment B24. The article of Embodiment B21, wherein the plurality of microspheres are transparent microspheres having refractive indices that are less than 1.55.

Embodiment B25. The article of Embodiment B21, wherein the binder resin layer is selected from at least one of linear resins and resins having low cross link densities.

Embodiment B26. The article of Embodiment B21, wherein the binder resin layer comprises a fluorine-containing polymer, and wherein the fluorine-containing polymer is derived in part from at least one partially fluorinated, or non-fluorinated, monomer.

Embodiment B27. The article of any of Embodiments B18, B19 and B21-B26, wherein the plurality of microspheres are selected from at least one of glass, polymers, glass ceramics, ceramics, metals and combinations thereof.

Embodiment B28. The article of any of the Embodiments B20-B27, wherein the binder resin layer is selected from at least one of the following linear materials: polyurethanes, polyureas, polyurethane ureas, polyesters, polycarbonate, BBS, polyolefins, acrylic and methacrylic acid ester polymers and copolymers, polyvinyl chloride polymers and copolymers, polyvinyl acetate polymers and copolymers, polyamide polymers and copolymers, fluorine containing polymers and copolymers, silicones, silicone containing copolymers, thermoplastic elastomers, such as neoprene, acrylonitrile butadiene copolymers, and combinations thereof.

Embodiment B29. The article of any of the Embodiments B1-B28, wherein the article is a film.

Embodiment B30. The article of any of Embodiments B1-B29, wherein a feature density of the article is in a range of 200 to 1000 per square millimeter.

Various modifications and alterations of this invention will become apparent to those skilled in the art without departing from the scope and spirit of this invention.

### EXAMPLES

The following examples and comparatives are of various textured surfaces that have ellipsoidal protrusions extending 10 to 75 micrometers from the surface of the article.

Materials

| | |
|---|---|
| DiPETPA | Dipentaerythritiolpentaacrylate, obtained from Arkema, Exton, PA under the |
| | trade designation “SR 399” |
| HDDA | 1,6 Hexanediol diacrylate, obtained from Arkema, Exton, PA under the trade |
| | designation “SR 238B” |
| D1173 | A photointiator obtained from BASF, Wyandotte, MI under the trade |
| | designation “Darocur 1173” |

Composition A

A radiation curable composition was prepared by mixing 75 wt. % DiPETPA, 25 wt. % HDDA, and 1 part per hundred D1173. About 100 grams of the composition were prepared.

### Example 1

A hemispherical array article was prepared using the following procedure. About 3 grams of Composition A were poured onto the upper microstructured face of a heated tool, with a portion of the tool shown in FIG. 9, and then spread uniformly using a 250 micrometer PET film as a doctor blade. The tool was a nickel plate measuring about 185 mm by 185 mm and 650 micrometers in thickness. The tool had microstructured surface consisting of an array of hemispherical cavities measuring 52 micrometers in diameter and a depth of 15 micrometers.

The tool rested on a magnetic hot plate set at 58 deg C. After filling the tool with Composition A, a clear 125 micrometer primed PET overlay film (DUPONT TEIJIN #617) was laminated to the upper face of the coated tool using an ink roller. The assembly consisting of the coated tool and the PET was placed on a conveyor belt and passed beneath a Fusion “D” lamp (Heraeus Noblelight America, Gaithersburg, Md.) set at 600 watts/2.5 cm (100% power setting) to irradiate the coated composition. The lamp was positioned 5 cm above the PET film. The conveyor was operated at 10.7 meter/min. After the cured composition was removed from the tool, the resin coated side of the PET was optionally exposed to a second UV exposure beneath the Fusion “D” lamp set at 600 watts/2.5 cm (100% power setting) on a conveyor at 10.7 meters/min. FIG. 10 is an image showing a portion of the article produced using the technique described above.

This article was then evaluated using the test methods described.

### Example 2

A pseudo Poisson ellipsoid array article was prepared using the following procedure. Resin Composition A was coated onto a 75 micrometer primed PET film (“DUPONT-TEIJIN #617”) using a conventional coating die as generally shown in FIG. 11. An excess of Composition A was provided such that a rolling bank of material was formed. The coated PET film was then nipped against the rotary metal tool with a rubber coated nip roll. The tool had a microstructured surface consisting of an array of hemispherical cavities measuring 52 micrometers in diameter and a depth of 15 micrometers with the cavity spacing determined using the semi-random pattern spacing algorithm described in WO00/59209.

The tool temperature was 79° C., and operated at a line speed of 3 meters/min. The coating was cured against the tool using a Fusion “D” lamp (Heraeus Noblelight America, Gaithersburg, Md.) set at 600 watts/2.5 cm (100% power setting) and positioned 5 cm from the surface of the tool to irradiate the coating composition through the film. The cured Composition A and PET film composite were removed from the rotary metal tool and then conveyed into a UV curing chamber equipped with a Fusion “D” lamp (Heraeus Noblelight America, Gaithersburg, Md.) set at 360 watts/2.5 cm (60% power setting) to provide additional cure. The lamp was positioned 5 cm from the surface of the cured coating.

This article was then evaluated using the test methods described.

### Comparative Example 1

C.Ex. 1 is a textured article comprised of glass microbeads embedded in a polymeric article as described in WO2014/190017 (Crystal Silk)

### Comparative Example 2

INNOLITE 501 HI, a commercially available high reflective fabric material sourced from InnoPac Korea Incorporated, Seoul, Korea, was evaluated using the test methods described.

### Comparative Example 3

AUTOTEX F200, a textured polyester film having a base polyester film substrate with a flexible, chemically bonded and UV-cured textured coating, commercially available from MacDermid Autotype Incorporated, Rolling Meadows, Ill. was evaluated using the test methods described.

### Comparative Example 4

KARESS SILVER, a specialty laminate film commercially available under the trade designation LUXEFILMS KARESS PEARLESCENT METALIZED, from LuxeFilms, Redwood Falls, Minn., was evaluated using the test methods described.

The sample surface textures of the examples and comparative examples were characterized using Surface Profilometry (method as described above) and various roughness parameters for the surface envelope were computed and tabulated in Table 4.

TABLE 4

| | Rq, | Rp, | Short | Long |
|---|---|---|---|---|
| | envelope | envelope | Range | Range |
| Example | (micrometers) | (micrometers) | Regularity | Regularity |
| Ex. 1 | 1.57 | 3.23 | 0.74 | 0.05 |
| Ex. 2 | 1.16 | 1.94 | 0.93 | 0.19 |
| C. Ex. 1 | 1.90 | 4.15 | 0.59 | 0.16 |
| C. Ex. 2 | 4.38 | 23.42 | −0.01 | 0.17 |
| C. Ex. 3 | 1.37 | 5.21 | 0.14 | 0.11 |
| C. Ex. 4 | 0.89 | 5.45 | −0.02 | 0.10 |

The sample surface textures of the examples and comparative examples were characterized using Surface Profilometry (method as described above) and various roughness parameters for the surface and the individual protrusions were computed and tabulated in Table 5.

TABLE 5

| | Irregular | Irregular | # of | | | | | |
|---|---|---|---|---|---|---|---|---|
| | protrusions, | protrusions, | protrusions/ | Surface, | Surface, | Ra, | RoC, | RoC, |
| | number | area | square | Rt | Sm | mean | mean | sharp |
| Example | fraction | fraction | millimeters | (μm) | (μm) | (μm) | (μm) | (μm) |
| Ex. 1 | 0.431 | 0.416 | 391.9 | 10.78 | 55.05 | 4.57 | −34.04 | −5.00 |
| Ex. 2 | 0.551 | 0.532 | 358.8 | 15.24 | 56.32 | 6.05 | −16.53 | −8.65 |
| C. Ex. 1 | 0.065 | 0.030 | 441.3 | 20.25 | 59.69 | 4.85 | −24.68 | −7.87 |
| C. Ex. 2 | 0.019 | 0.011 | 202.4 | 33.45 | 80.69 | 9.17 | −37.49 | −11.05 |
| C. Ex. 3 | 0.830 | 0.881 | 567.2 | 6.94 | 86.43 | 1.75 | −78.32 | −10.08 |
| C. Ex. 4 | 0.966 | 0.905 | 154.4 | 1.31 | 49.96 | 0.260 | −87.17 | −7.09 |

Haptic (Touch) Perception Results

The overall average and the standard error of Haptic Perception Results are reported in Table 6.

TABLE 6

| | | Overall |
|---|---|---|
| | Overall | Preference |
| | Average | standard |
| Ex. No. | Preference | error |
| Ex. 1 | 7.61 | 0.13 |
| Ex. 2 | 8.68 | 0.09 |
| C. Ex. 1 | 6.91 | 0.13 |
| C. Ex. 2 | 2.66 | 0.50 |
| C. Ex. 3 | 5.20 | 0.23 |
| C. Ex. 4 | 2.55 | 0.56 |

What is claimed is:

1. An article comprising:
a major textured surface having a plurality of ellipsoidal protrusions,
wherein the plurality of ellipsoidal protrusions is disposed in repeated units, and
wherein each of the repeated units has a pseudorandom pattern, such that is a degree of short range regularity of the pseudorandom pattern is greater than 0.5 and a degree of long range regularity of the pseudorandom pattern is less than 0.5.

2. The article of claim 1, wherein the degree of short range regularity is a normalized nearest neighbor distance coefficient of variation minus by one, wherein the normalization is performed using a nearest neighbor distance coefficient of variation for a random map with a same feature density as the article.

3. The article of claim 1, wherein the degree of long range regularity is a normalized azimuth angle coefficient of variation, wherein the normalization is performed using an azimuth angle coefficient of variation for a regular map with a same feature density as the article.

4. The article of claim 1, wherein a spatial FFT spectrum of the pseudorandom pattern has one or more rings and has a relatively high spectral energy proximate to the one or more rings and relatively low spectral energy away from the one or more rings.

5. The article of claim 1, wherein the major textured surface has an envelope Rq of less than 2.25 micrometers, an envelope Rp of less than 5.5 micrometers and an Rt of greater than 10 micrometers.

6. The article of claim 1, wherein the textured surface has a perception preference rating between 6.40 and 10.00.

7. The article of claim 1 wherein the textured surface has a perception preference rating greater than or equal to 7.25.

8. The article of claim 1, wherein the centers of the ellipsoidal protrusions are a distance of 25 to 100 micrometers from each other.

9. An article comprising:
a major textured surface having a plurality of ellipsoidal protrusions,
wherein the plurality of ellipsoidal protrusions is disposed in repeated units, and
wherein each of the repeated units has a pseudorandom pattern, such that a spatial FFT spectrum of the pseudorandom pattern has one or more rings and has a relatively high spectral energy proximate to the one or more rings and relatively low spectral energy away from the one or more rings.

10. The article of claim 9, wherein a degree of short range regularity of the pseudorandom pattern is greater than 0.7 and a degree of long range regularity of the pseudorandom pattern is less than 0.5.

11. The article of claim 10, wherein the degree of short range regularity is a normalized nearest neighbor distance coefficient of variation minus by one.

12. The article of claim 11, wherein the normalization is performed using a nearest neighbor distance coefficient of variation for a random map with a same feature density as the article.

13. The article of claim 10, wherein the degree of long range regularity is a normalized azimuth angle coefficient of variation.

14. The article of claim 13, wherein the normalization is performed using an azimuth angle coefficient of variation for a regular map with a same feature density as the article.

15. The article of claim 9, wherein the major textured surface has an envelope Rq of less than 2.25 micrometers, an envelope Rp of less than 5.5 micrometers and an Rt of greater than 10 micrometers.
